(19) United States
(12) Patent Application Publication
(10) Pub. No.: US 2006/0255127 A1
(43) Pub. Date: Nov. 16, 2006

(54) SYSTEM, METHOD, AND COMPUTER PROGRAM PRODUCT FOR BIOMETRIC RADIOFREQUENCY ID

(76) Inventor: Michael E. Woods, Tiburon, CA (US)

Correspondence Address: MICHAEL E. WOODS;PATENT LAW OFFICES OF MICHAEL E. WOODS, 112 BARN ROAD, TIBURON, CA, 94920-2602, US

(21) Appl. No.: 11/308,846

(22) Filed: May 15, 2006

Related U.S. Application Data
(60) Provisional application No. 60/594,874, filed on May 14, 2005.

(51) Int. Cl. G06K 19/06; G06K 5/00

(52) U.S. Cl. 235/380; 235/492

(57) ABSTRACT

An apparatus including a biometric scanner to determine a user profile of a user; a radiofrequency ID (RFID) responsive to a configuration signal to set a dynamic attribute of said RFID; and a processing system, coupled to said scanner and to said RFID, for asserting said configuration signal when a validation of said user profile indicates said user is an authorized user to enable an RFID reader to establish said RFID as an authorized-user indicating RFID.

### BACKGROUND OF THE INVENTION

The present invention relates generally to radiofrequency identification (RFID), and more specifically to biometric-mediated RFID tags, systems, methods, and articles of manufacture.

Radio frequency identification (RFID) is a method of remotely storing and retrieving data using devices called RFID tags/transponders. An RFID tag is a small object, such as an adhesive sticker, that may be attached to or integrated into a product or object. RFID tags contain antennas to enable them to receive and respond to radio-frequency queries from an RFID transceiver. RFID tags may be either classified as active or passive.

Passive RFID tags do not have an associated power supply: minute electrical currents are induced in the antenna by an incoming radio-frequency scan and these currents provide enough power for the tag to send a response. Due to power and cost concerns, the response of a passive RFID tag is necessarily brief: typically just an ID number, such as a globally unique identifier (GUID) or other universally unique identifier (UUID) for example. Lack of its own power supply enables passive RFID tags to be quite small: commercially available products exist that may be embedded under the skin. As of 2004, the smallest such devices commercially available measured approximately 0.4 mm×0.4 mm, and thinner than a sheet of paper; making such devices practically invisible. Passive tags have practical read ranges that vary from about 10 mm up to about 5 meters.

Active RFID tags, on the other hand, typically require an associated power source, and may have longer ranges and larger memories than passive tags, as well as the ability to store additional information sent by the transceiver. At present, the smallest active tags are about the size of a coin. Many active tags have practical ranges of tens of meters, and a battery life of up to several years.

As passive tags are much cheaper to manufacture and do not depend on a battery, the vast majority of RFID tags in existence are of the passive variety. As of 2004 tags cost from about US$0.40. It has been stated that one price goal is to produce tags for less than US$0.05 which would make widespread RFID tagging commercially viable. However, chip manufacturers' supply of integrated circuits is not sufficient and demand is too low to expect prices to come down soon. Analysts from independent research companies like Gartner and Forrester Research agree that a price level of less than $0.10 is only achievable in 6-8 years, a potential hurdle to widespread passive RFID adoption. However, using some new manufacture techniques may lower the price of RFID at a faster pace.

While the cost advantages of passive tags over active tags are significant, other factors including accuracy and reliability make the use of active tags very common today.

There are four different kinds of tags commonly in use. They are categorized by their radio frequency: Low frequency tags (between 125 to 134 kilohertz), High frequency tags (13.56 megahertz), UHF tags (868 to 956 megahertz), and Microwave tags (2.45 gigahertz). UHF tags cannot be used globally at present as global regulations for their usage do not yet exist.

An RFID system typically consists of one or more elements selected from several component types: tags, tag readers, tag programming stations, circulation readers, sorting equipment, and tag inventory wands. As an example, consider how security is typically handled in a library environment. There are basically two types of security, security gates query a client/server integrated library system (ILS) to determine a security status of the tag or the tag may contain a security bit which would be turned on and off by circulation or self-check reader stations.

One purpose of an RFID system is to enable data to be transmitted by a portable device, called a tag, which is read by an RFID reader and processed according to the needs of a particular application. The data transmitted by the tag may provide identification or location information, or specifics about the product tagged, such as price, color, date of purchase, and the like. The use of RFID in tracking and access applications first appeared during the 1980s. RFID quickly gained attention because of its ability to track moving objects. As the technology is refined, more pervasive-and invasive-uses for RFID tags are in the works.

In a typical RFID system, individual objects are equipped with a small, inexpensive tag. The tag contains a transponder with a digital memory chip that is given a unique electronic product code. The interrogator, an antenna packaged with a transceiver and decoder, emits a signal activating the RFID tag so it may read and write data to it. When an RFID tag passes through the electromagnetic zone, it detects an activation signal from the reader/interrogator. The reader decodes the data encoded in an integrated circuit of the tag and the data is passed for further processing, such as to a host computer for processing.

Take the example of books in a library. Security gates can detect whether or not a book has been properly checked out of the library. When users return items, the security bit is re-set and the item record in the ILS is automatically updated. In some RFID solutions a return receipt may be generated. At this point, materials may be roughly sorted into bins by the return equipment. Inventory wands provide a finer detail of sorting. This tool may be used to put books into shelf-ready order.

Low-frequency RFID tags are commonly used for animal identification, beer keg tracking, and automobile key-and-lock, anti-theft systems. Pets are often embedded with small chips so that they may be returned to their owners when lost. In the United States, two RFID frequencies are used: 125 kHz (the original standard) and 134.5 kHz, the international standard.

High-frequency RFID tags are used in library book or bookstore tracking, pallet tracking, building access control, airline baggage tracking, and apparel item tracking. High-frequency tags are widely used in identification badges, replacing earlier magnetic stripe cards. These badges need only be held within a certain distance of the reader to authenticate the holder.

UHF RFID tags are commonly used commercially in pallet and container tracking, and truck and trailer tracking in shipping yards.

Microwave RFID tags are used in long range access control for vehicles.

Implantable RFID “chips”, originally designed for animal tagging are being used and contemplated for humans as well. Applied Digital Solutions proposes their chip's “unique under-the-skin format” as a solution to identity fraud, secure building access, computer access, storage of medical records, anti-kidnapping initiatives and a variety of law-enforcement applications. Combined with sensors to monitor body functions, the Digital Angel device could provide monitoring for patients. The Baja Beach Club in Barcelona, Spain uses an implantable Verichip to identify their VIP customers, who in turn use it to pay for drinks. The Mexico City police department has implanted approximately 170 of their police officers with the Verichip, to allow access to police databases and possibly track them in case of kidnapping. Amal Graafstra, a Washington state native and business owner, had a RFID chip implanted in his left hand in early 2005. The chip was 12 mm long by 2 mm in diameter and has a basic read range of two inches.

The NEXUS program combines fingerprinting, digital photographs and RFID to facilitate swift and secure border crossings between the U.S. and Canada. To enroll in the program, frequent travelers are interviewed, fingerprinted and subject to a background check. If accepted, they receive a NEXUS photo ID card that includes an embedded RFID chip.

With that card, a NEXUS program participant can access specially designated crossing lanes. Once in the lane, he or she holds the card up to an RFID reader positioned in front of the inspection booth. The reader flashes the participant's photo and information onto a computer screen inside the booth. The inspector verifies that the photo on the screen matches the vehicle occupant and, if all checks out, authorizes the car to proceed. If there is more than one NEXUS participant in the vehicle, the reader and screen can display several photos for visual identification at once.

RFID is also the driver behind a similar program used to identify international cargo, instead of passengers. More than 40 partners, including many of the busiest ocean ports in the world, numerous multinational customs agencies and other government bodies, logistics companies, and technology providers are cooperating in the Smart & Secure Tradelanes (SST) program to track and secure cargo. Cargo containers are inspected at the port of origin and locked with an RFID cargo seal. Project participants are building a worldwide network of readers and sensors to track the movement of the tagged cargo and detect unauthorized movements. RFID, satellite tracking and Internet-based reporting all play a role in the system.

There are numerous RFID and biometrics standards activities underway at industry, national and international levels. While the volume of standards work is too large to chronicle here, a few projects merit mention. The ISO, which is the leading international standards authority, and whose standards carry the weight of law in some countries, established a new committee, ISO JTC1 SC37, in December 2002, to spearhead biometrics standards. ISO has already ratified several RFID standards and many more are close to being finalized. In May, ISO formally became involved with the SST program to gain insight to set international supply chain security and visibility standards.

The standard being developed and implemented provides for use of RFID and biometrics in parallel, using both to provide enhanced security. A user simultaneously passes a biometric check while in an RFID detection zone that detects a valid RFID tag. The biometric check is often validation of a facial profile but other types of biometrics are used.

While biometrics offer reliable security by itself, in some situations it is undesirable or unfeasible to employ biometric scanning systems in all locations and situations. What is needed is an improved biometric system that makes implementation and use simpler and more efficient.

### BRIEF SUMMARY OF THE INVENTION

Disclosed is an apparatus including a biometric scanner to determine a user profile of a user; a radiofrequency ID (RFID) responsive to a configuration signal to set a dynamic attribute of said RFID; and a processing system, coupled to said scanner and to said RFID, for asserting said configuration signal when a validation of said user profile indicates said user is an authorized user to enable an RFID reader to establish said RFID as an authorized-user indicating RFID.

The preferred embodiment provides an improved biometric system for simpler, more efficient use of biometric profiles.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a schematic view of a computer network, implementing a preferred embodiment of the present invention; and

FIG. 2 schematically illustrates the main components of a generic computer of the network shown in FIG. 1.

### DETAILED DESCRIPTION OF THE INVENTION

The present invention relates generally to biometric-mediated RFID tags, systems, methods, and articles of manufacture. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein. As the present invention is applicable to many different types of communications systems, the following description simplifies explanation by explaining the invention in terms of e-mail distribution systems and telephone networks. The invention may be simply adapted and extended for other communications systems.

RFID tags, systems, and methods, and biometric systems, are both technologies that have progressed and are well established in independent implementations. Recent developments have provided for use of these technologies in independent parallel implementations as an aid to enhancing the security offered by biometrics alone. That is, a biometric profile is checked in conventional fashion as an RFID tag is checked in parallel. It is an aspect of the preferred embodiment of the present invention to use these technologies synergistically, such as in a preferred embodiment in which a result of one technology affects the other technology (referred to herein as a serial implementation). Depending upon implementation and application details, either of the technologies may be triggered first, thereafter influencing the other.

For example, a result of a biometric profile scan may dynamically change an attribute of the RFID system, which is then subsequently interrogated. In the preferred embodiment, the RFID system simplifies use of the results of a biometric scan. In another example, data from the RFID system influences the biometric scan/testing process. Further details are described below.

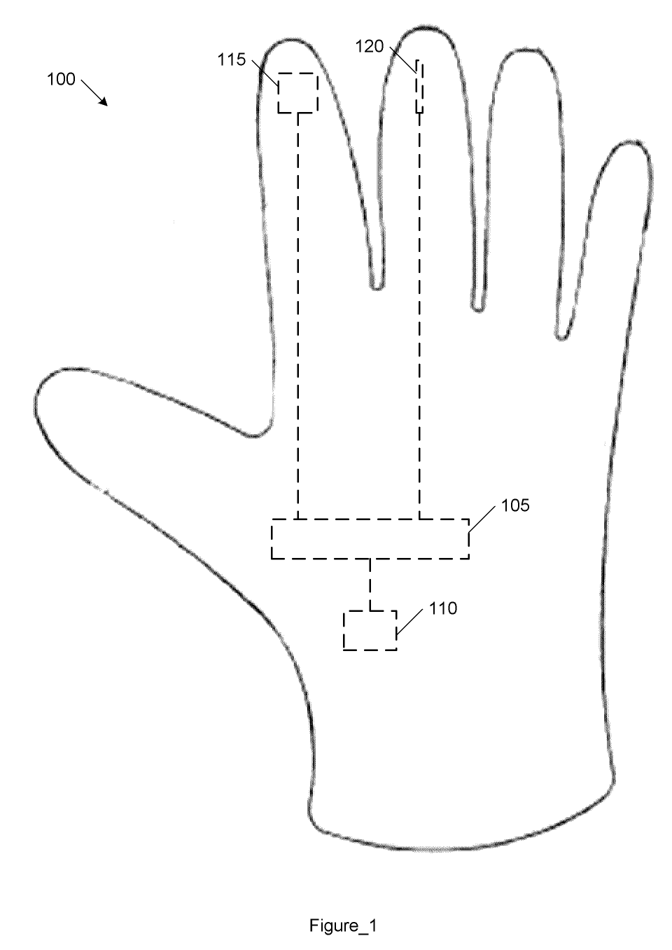

FIG. 1 is an illustration of a preferred embodiment of the present invention implemented a biometric-mediated RFID glove 100. Glove 100 includes a bio-RFID processor 105 powered by an internal power supply (e.g., a battery 110) when needed or desired. Bio-RFID processor 105 interfaces to a biometric system 115 (shown as a fingerprint reader) and an RFID system 120 (shown here as an RFID tag).

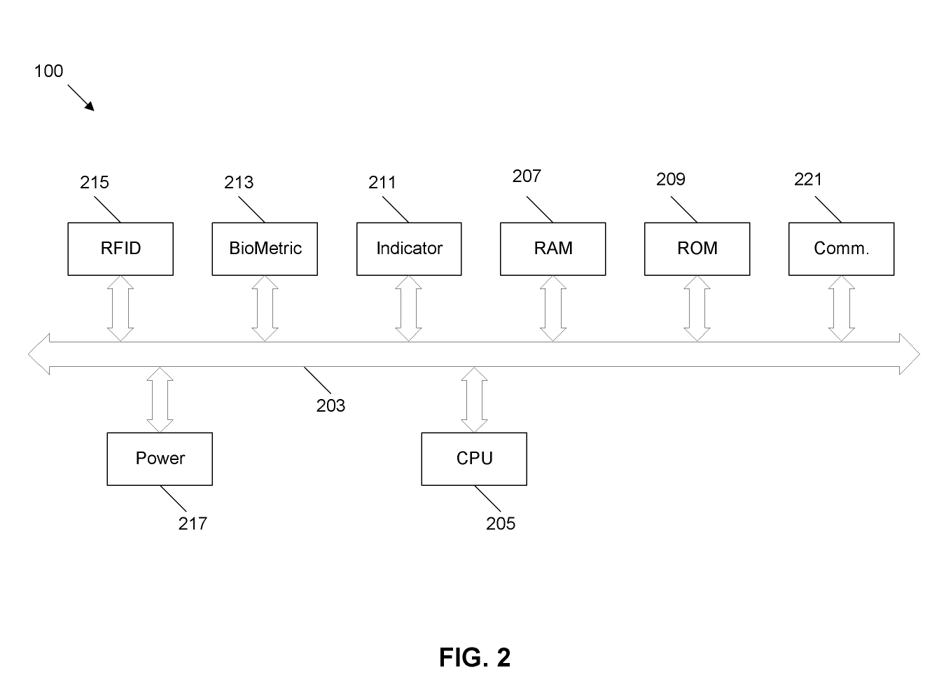

FIG. 2 is a generic schematic for bio-RFID processor 105 including several functional units connected in parallel to a data communication bus 203, for example of the PCI type. In particular, a Central Processing Unit (CPU) 205, typically comprising a microprocessor or microcontroller or the like, controls the operation of bio-RFID processor 105, a working memory 207, typically a RAM (Random Access Memory) is directly exploited by the CPU 205 for the execution of programs and for temporary storage of data, and a Read Only Memory (ROM) 209 stores a basic program for the bootstrap of bio-RFID processor 105. Bio-RFID processor 105 may include peripheral units, connected to bus 203 by use of respective and appropriate interfaces. Particularly, the peripheral units that allow interaction with biometric system 115 and RFID system 120 (respectively shown as Biometric interface 213 and RFID interface 215). Bio-RFID processor 105 may also include, in some implementations, peripheral units for local mass-storage of programs (operating system, application programs) and data, such as one or more persistent memory device drivers, driving additional memory systems such as flash memory or field-programmable read/write devices. Other peripheral units may be present, such as a memory card reader for reading/writing memory cards and the like. Bio-RFID processor 105 may optionally be equipped with a power source 217 and/or a Network Interface Adapter (NIA) function 221 for the connection to a data communication network (such as for example a wireless network IEEE 802.11 or Bluetooth or the like. NIA function 221 may transfer data to/from glove 100 or its subsystems/components.

In operation, the preferred embodiment provides a simple mechanism to convey a result of a biometric scan to a remote processing system without requiring biometric scanners. Because of the more intimate requirements of biometric scanners, there exists a certain difficulty and resistance to implementation. The present invention permits substitution of an RFID reading/interrogator system to review, monitor, respond to RFID information that reflects results of a biometric scan.

There are two approaches to biometric systems: biometric systems may precisely match a test biometric profile against a stored biometric profile to precisely identify the person producing the profile; or precisely match a test profile against a set of biometric profiles to identify a classification for the person producing the profile. In the former case, when a test profile from candidate x matches a stored profile associated with user x, the system determines that candidate x is user x. When a test profile is matched against a set of profiles, the test result indicating that the test profile matches one of the set members indicates a classification for the user but does not otherwise determine which specific match was successful. When the set of candidate profiles are a set of authorized users, matching a test profile into this candidate set is sufficient to authorize the user associated with the test profile. Similarly, candidate classes may be developed for unauthorized users, or for different levels/privileges and matches of a test profile into a specific classification set results in the user inheriting the appropriate classification set attributes. Glove 100 may be configured for operation using either approach.

A user dons glove 100 and biometric system 115 is activated at some point thereafter. Either the act of placing glove 100 over the hand of the user or some other act (for example a manual signal from the user or an automatic signal such as an interrogation of glove 100 by an RFID system or by a periodic poll from processor 105. An important aspect of the preferred embodiment of the present invention is that the RFID and the biometric systems provide a direct synergistic cooperation. Processor 105 dynamically sets an attribute of glove 105 using biometrics and/or RFID attributes. For example, in one preferred embodiment, a result of a biometric scan dynamically controls the RFID identification tag. In this way, results of a local (local to glove 100) biometric test are made available remotely using the RFID subsystem. Either the RFID attribute is set dynamically (e.g., a specific ID identifying the user or a classification for the user), or an operational status of the RFID subsystem is dynamically set (e.g., ON/OFF or ENABLED/DISABLED), based upon the biometric scan or scanned profile. In the operational status enabling/disabling, the RFID subsystem has predefined attributes (like a user ID) but a remote reader is unable to interact/detect the ID (such as the antenna or other component/system of the RFID subsystem has been dynamically altered or adjusted. If power is needed, the power may be controlled by an on/off switch to dynamically implement this aspect of the preferred embodiments.

For example, in a preferred embodiment, a hash function is used to convert the biometric profile into a dynamic property of the RFID system. Certain reproducible attributes of the biometric scan produced from biometric subsystem 115 create a unique or sufficiently-unique attribute for RFID subsystem 120 so that the benefits of the biometric subsystem are locally determined but remotely detected and responded to. In this fashion, RFID subsystem 120 provides a remotely detectable status of the biometric subsystem. In this way, biometric profiles are scanned locally and detected remotely so simpler user processing stations may be used. Each user processing station does not need to have a biometric scanner. In other preferred embodiments, the RFID subsystem initiates a biometric scan to generate a user profile. Glove 100 may then process the profile or pass the profile on, for example using the network features. Or the RFID subsystem may be configured as discussed above to indicate a response to the RFID-initiated process.

These are not just for security applications, but also user convenience to enable systems to customize themselves to individual specific users or between authorized and unauthorized users. That is, such preferred embodiments are simple aids to configuring electronic systems using user-specific settings, options, parameters, and the like reported by the RFID system. In some such embodiments, glove 100 is provided with an RFID system only so the user may easily configure options by touching them or otherwise moving the hand wearing the glove within range of a detecting station.

In other embodiments and preferred embodiments, an RFID subsystem-only system (including processor 105 when necessary) may be incorporated into other form factors and objects. For example, dynamic RFID systems may be employed to report elapsed time or date/time of initiation of a timing period, or other attribute to be monitored. In this implementation, an RFID reader suitably equipped to read and decode the dynamic RFID data reads the data and processes it according to the application. For example, using a “counting RFID” system permits a tag to be applied to an object and later determine an elapsed time after the application of the tag to the object. One implementation would be monitoring automobile parking durations in a restricted/controlled parking area.

Additionally, a plurality of RFID tags (RFIDs) may each be provided in a system, with the processing system selectively enabling one or more of the RFIDs (or some manual switch may be used or other switching mechanism) to indicate some condition or attribute. For example, a glove could be configured to work with several people, each having an identifier represented by one tag. The biometric system determines which person is wearing the glove and enables the proper RFID. Other uses for multiple RFID tags are possible.

Further, one configuration includes in well-known fashion an RFID reader incorporated into the system, (e.g., the glove). The combination of the embedded RFID tags and the reader permit an interactivity between a user and a product to be assessed and measured. That is for the glove example, glove A is properly picking up product B. Additionally, with the biometric feature, it may be determined whether person A is picking up product B. Further, the processing system may either dynamically set an RFID identifier responsive to the read RFID, or enable the correct one of a plurality of RFIDs based upon the results of the processing and interaction of the system, the external product/location indicated by the external RFID tag, and the user. Improved security systems are possible. In some cases, a communications network is provided to communicate the processing results.

Although embodiments of the invention have been described primarily with respect to communications channels implemented using familiar communications systems like computer networks and telephone networks, many types of communications systems may benefit from features of the present invention. Providing a user with direct feedback of the availability of operational readiness of an electronic device beyond signaling availability of a reduced condition improve user experiences and satisfaction.

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention, for example for the switching control, is as a routine in an operating system made up of programming steps or instructions resident in a memory of a computing system during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a preferred embodiment” or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Therefore the scope of the invention is to be determined solely by the appended claims.

What is claimed as new and desired to be protected by Letters Patent of the United States is:

1. An apparatus, comprising:
a biometric scanner to determine a user profile of a user;
a radiofrequency ID (RFID) responsive to a configuration signal to set a dynamic attribute of said RFID; and
a processing system, coupled to said scanner and to said RFID, for asserting said configuration signal when a validation of said user profile indicates said user is an authorized user to enable an RFID reader to establish said RFID as an authorized-user indicating RFID.

2. The apparatus of claim 1 wherein said biometric scanner is a fingerprint reader.

3. The apparatus of claim 1 wherein said dynamic attribute is a security bit.

4. The apparatus of claim 1 wherein said dynamic attribute is an RFID tag number.

5. The apparatus of claim 1 wherein said scanner, said RFID, and said processing system are incorporated into a portable object attachable to said user.

6. The apparatus of claim 5 wherein said portable object is an apparel object wearable by said user.

7. The apparatus of claim 6 wherein said apparel object is a glove.

8. The apparatus of claim 6 wherein said biometric scanner is a fingerprint reader disposed within an internal portion of a wall of a finger-containing portion of said glove to determine said user profile while said glove is worn.

9. A method, the method comprising:
a) determining a biometric profile of a user using a biometric scanner incorporated into an object worn by said user;
b) setting dynamically, responsive to said biometric profile determination, an attribute of a radiofrequency ID (RFID) system.

10. The method of claim 9 wherein said object is an article of clothing worn on a hand of a user and wherein said biometric scanner includes a fingerprint reader.

11. A computer program product comprising a computer readable medium carrying program instructions for manufacturing a transport when executed using a computing system, the executed program instructions executing a method, the method comprising:
a) determining a biometric profile of a user using a biometric scanner incorporated into an object worn by said user;
b) setting dynamically, responsive to said biometric profile determination, an attribute of a radiofrequency ID (RFID) system.

12. The computer program product of claim 11 wherein said object is an article of clothing worn on a hand of a user and wherein said biometric scanner includes a fingerprint reader.

13. A propagated signal on which is carried computer-executable instructions which when executed by a computing system performs a method, the method comprising:
a) determining a biometric profile of a user using a biometric scanner incorporated into an object worn by said user;
b) setting dynamically, responsive to said biometric profile determination, an attribute of a radiofrequency ID (RFID) system.

14. The signal of claim 13 wherein said object is an article of clothing worn on a hand of a user and wherein said biometric scanner includes a fingerprint reader.

15. An apparatus, comprising:
a plurality of radiofrequency IDs (RFIDs), each responsive to a configuration signal to set a dynamic attribute of said RFID; and
a processing system, coupled to said RFIDs, for asserting said configuration signals to selectively enable a particular one RFID.

16. The apparatus of claim 15 wherein said plurality of RFIDs and said processing system are integrated into a wearable system for a user.

17. The apparatus of claim 16 further comprising a biometric scanner, coupled to said RFIDs and to said processing system, to determine a user profile of said user.

18. The apparatus of claim 17 wherein said configuration signal to said particular one RFID enables said RFID when said user profile validates said user against a database of valid users.

19. The apparatus of claim 1 further comprising an internal RFID reader other than said RFID reader, coupled to said processing system, for reading an external RFID other than said RFID.

20. The apparatus of claim 15 further comprising an RFID reader, coupled to said processing system, for reading an external RFID other than one of said plurality of RFIDs wherein said configuration signals are responsive to said external RFID.
